(19) United States
(12) Patent Application Publication
(10) Pub. No.: US 2024/0386396 A1
(43) Pub. Date: Nov. 21, 2024

(54) SYSTEM AND METHOD FOR STREAMLINED SHOPPING

(71) Applicant: Sava ZIVANOVIC, Belgrade (RS)

(72) Inventor: Sava ZIVANOVIC, Belgrade (RS)

(21) Appl. No.: 18/695,819

(22) PCT Filed: Sep. 29, 2022
(86) PCT No.: PCT/IB2022/059304

§ 371 Date: Mar. 27, 2024

Related U.S. Application Data
(60) Provisional application No. 63/249,961, filed on Sep. 29, 2021.

(51) Int. Cl. G06Q 20/02; G06Q 20/40

(52) U.S. Cl. CPC G06Q 20/02; G06Q 20/401

(57) ABSTRACT

A system and method include a mobile device to execute an application to obtain a code comprising identifying information associated with an item, the scan of identifying information triggering protected communications resulting in a transfer of value through an intermediary without secure data being provided to either the first party utilizing the mobile device or the item provider. The code can be scanned by the mobile device or communicated to the mobile device from an NFC device. Connectors interface with external systems, such as an item provider's database representing stock status, or an intermediary's database representing secure data in the form of payment information facilitating an exchange of value by the intermediary from the user of the mobile device to the item provider.

### CROSS-REFERENCE TO RELATED APPLICATION

This application claims priority to U.S. Patent Application Ser. No. 63/249,961, filed on Sep. 29, 2021, and entitled “SYSTEM AND METHOD FOR STREAMLINED SHOPPING”, the entirety of which is hereby incorporated by reference in its entirety for all that it teaches and suggests.

### BACKGROUND OF THE DISCLOSURE

### 1. Field of the Disclosure

The disclosure relates in general to secure network communications, and more particularly, to a system and method for limiting the exchange, through network communications, of protected data.

### 2. Background Art

The retail industry is at the crossroad. For example, the retail industry is facing challenges such as COVID (lockdowns, social distance), pressure of the new “Instant” generation (“want it now”), e-commerce growth, non-synced warehouse database solutions, etc. Such challenges include working hours limitations with no possibility of selling the products out of store hours and limited points of sales with queuing and limitation of ways to bus a product or a service to only some locations and time periods. Also, low conversion rates due to not optimized shopping.

Shopping cart abandonment rate can be as high as 92% As checkout processes add additional high costs, account issues, complicated check out and low security, this results in loss of billions in sales & damaged customer experience. For example, higher extra costs-information is displayed on a product, and the price is not fixed with additional delivery costs and/or taxes being added to a cost. Also, the need to create an account deters some customers. For example, in some instances a customer completes a checkout section, but only when clicking on “Pay” do they realize that they cannot make a purchase until they create a user account.

Security and privacy breaches are also a concern for customers. Customers have been damaged by privacy breaches at retailers which have resulted in the customers' credit card information, or other secure information, such as bank account numbers, social security numbers, or other like secure information, having been obtained by malicious actors who have then used such secure information to the customers' detriment. As such, customers are desirous of limiting the quantity of retailers or other like entities to whom the customers reveal such secure information.

All these elements lead to loss of billions in sales on merchant sites and damaged shopping customer experience. In order to survive, the retail industry should response to high expectations of customers.

### SUMMARY OF THE DISCLOSURE

The disclosure is directed to a method comprising generating messages comprising identifiers utilizable by a router to route messages between a first party acquiring an item, an item provider providing the item, and an intermediary that retains a secure data that is utilized to effectuate a transfer between the first party and the item provider without the secure data being exchanged via the messages, and without the secure data being disclosed to the item provider.

In at least one configuration of the method, identifying information that is utilizable to generate an initiating message is one of a QR code, a bar code, a deep link or a near-field communication (NFC) device.

The disclosure is also directed to a system including a mobile device and a router, the router routing messages between a first party acquiring an item, an item provider providing the item, and an intermediary that retains a secure data that is utilized to effectuate a transfer between the first party and the item provider without the secure data being exchanged via the messages, and without the secure data being disclosed to the item provider.

In at least one configuration of the system, the router acts as a centralized communications hub, enforcing anonymity and security.

### BRIEF DESCRIPTION OF THE DRAWINGS

The disclosure will now be described with reference to the drawings wherein:

FIG. 1 illustrates an example system for increasing data security and reducing network congestion, in accordance with at least one configuration disclosed herein;

FIG. 2 illustrates an example flow diagram of a method for increasing data security and reducing network congestion, in accordance with at least one configuration disclosed herein; and

FIG. 3 illustrates an exemplary general-purpose computing device, in accordance with at least one configuration disclosed herein.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

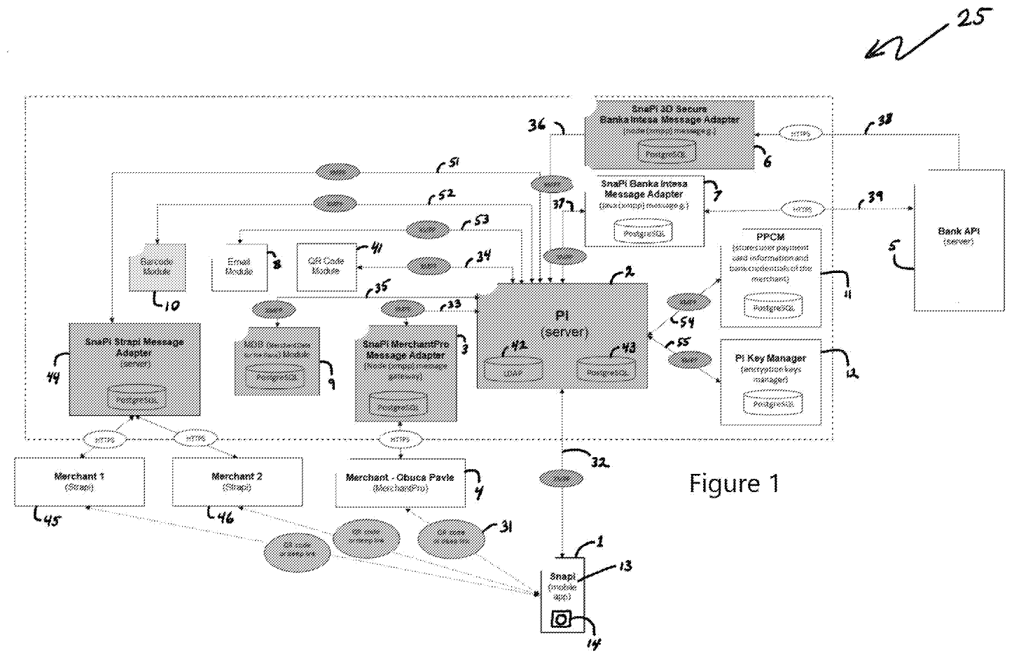

Referring now to the drawings and in particular to FIG. 1, a shopping system 25 is disclosed that includes a mobile device 1 executing an application 13 that enables the mobile device to interact with a message router in the form of server 2. For purposes of the descriptions provided herein terms “router” and “server” will be used interchangeably when referencing the server 2 shown in FIG. 1. The shopping system 25 further includes providers of items, in the form of merchants 4, 45 and 46. According to one aspect, item providers, such as the merchants 4, 45 and 46 can interact with the router 2 through adapters or connectors, such as the message adapters 3 and 44. For purposes of the descriptions provided herein the terms “adapter” and “connector” will be used interchangeably when referencing the adapters 3, 6, 7 and 44 shown in FIG. 1. The shopping system 25 further includes one or more banks, such as the bank 5, represented in the form of an Application Program Interface (API) implemented by the bank 5 to enable the system 25 to interact with the bank 5 without the bank being required to reveal internal bank data and/or processes to the system 25.

To overcome the deficiencies within the art described above, the disclosed application, or “app”, identified herein as application 13, allows a customer via a mobile device 1 executing the application 13 to consume identifying information in the form of a code for a particular product or service that the customer desires to purchase. The code can take many forms, tailored to the particular environment within which such a code is to be presented to users. For example, the code can take the form of a QR code which can be presented in many different locations and environments, such in a shop window, on a billboard, on a display device, or the like. As another example, the code can take the form of a deep-link that can be accessed through an application executing on a computing device, such as a browser application, content creation application, social media application and the like.

As yet another example, the code can take the form of a Near Field Communication (NFC) device, which, through near field communications, can transfer the data that the code comprises to a receiving computing device or other like receiver. NFC devices can be particularly useful in populated or crowded environments such as concerts, exhibitions, trade shows, and the like. More specifically, NFC devices can be utilized to minimize network traffic and congestion by reducing the quantity of messages exchanged. While codes, such as QR codes, can comprise sufficient data to enable the generation of communications that specify both a specific item, and a specific item provider, NFC devices can provide richer information comprising more data. For example, an NFC device can provide sufficient information to enable the mobile device 1, communicating with such an NFC device, to receive and display item information, such as images, textual description, cost and other like item information. In such an instance, such information, which would otherwise have been provided to the mobile device 1 through network communications, can, instead, be received through NFC communications from the NFC device, thereby avoiding generating network messages and reducing network traffic, which can be especially beneficial in populated or crowded environments where networks are often congested to the point of failure. External hardware and/or internal software mechanisms can be added to the mobile device 1 so as to allow the NFC communication to further enable the purchasing of an item through a Non-Fungible Token (NFT).

Other types of codes are equally contemplated. Irrespective of the specific structure of the code, the code can comprise an identifier associated with a product or service and an identifier associated with the provider of such a product or service, and enables the user make a purchase with a single “click” of a button, such as would be displayed by application 13 upon consumption of the code. As utilized herein, the term “item” is meant to include physical or virtual products, physical or virtual services, or combinations thereof. Thus, the mobile device 1 running the application 13, along with the rest of the shopping system 25 allows the customer to make a purchase efficiently, such as with a single click on the application 13. Thus, this simplified purchasing streamlines the shopping experience for a customer.

Initially, an item provider, such as the merchant 4 can generate a code, such as the QR code 31, which the item provider can then distribute, such as detailed above. The code can comprise an identifier of an item, such as an item being offered for sale by the merchant 4, as well as information that can enable the router 2 to appropriately route messages generated from such a code. For example, the QR code 31 can comprise an identifier of the merchant 4 within the context of the system 25. Such an identifier can be a known network identifier. However, to provide greater security, the router 2 can implement a virtual private network that can assign private identifiers to individual entities including, for example, the merchant 4. Such private identifiers, as will be detailed below, can identify either the merchant 4 directly, or can identify a connector, such as the message adapter 3, being executed by, or on behalf of, the merchant 4.

According to one aspect, communications within the system 25 can utilize the Extensible Messaging and Presence Protocol, referred to herein as “XMPP”, for the generation and exchange of messages. Messages are encrypted utilizing known message encryption and/or network communication securing mechanisms. Thus, for example, upon scanning the QR code 31, the application 13 can utilize the information contained within the QR code 31 to generate an XMPP message 32 to the router 2. The XMPP message 32 can contain an identifier that can enable the router 2 to route the message to the merchant 4, such as in the form of the message 33. The message 33 can be received by the merchant 4, such as by executing the message adapter 3, or by having the message adapter 3 be executed on behalf of the merchant 4, such as by a provider of the system 25. The message adapter 3 can, based on the information within the message 33, identify a particular item and can interact with internal merchant software, databases, and other like existing data stores and data processes. Once the item is confirmed by the merchant and ready to be provided to a customer, which will be referred to herein as the “first party”, the system 25 can interact with an intermediary, such as the bank 5 to facilitate transfer of value, such as in the form of physical or virtual currency, data, or other like value enumerations. Alternatively, or in addition, the router 2 can have access to payment information directly, such as via the database 11, which can be maintained by the router 2, or can otherwise be part of the system 25. In such an instance, the transfer of value can be facilitated by the router 2, such as, for example, by providing previously stored user credit card information to the bank 5.

As with a merchant, such as the merchant 4, a bank can also interface with the system 25 through connectors such as the adapters 6 and 7, which can receive communications 36 and 37, respectively, and can generate medications 38 and 39, respectively, which can be in a form to properly interface with a bank API as shown in FIG. 1. To prevent the transmission of secure data, such as credit card information, bank credentials, or other like secure data to individual merchants, the system 25 can provide for a single storage of such secure data, such as within the database 11, which can share relevant information only with the router 2. More specifically, the router 2 access the database 11 via a connector that controls access. To protect the secure data stored in the database 11, the secure data is stored in such a manner that the router 2 cannot decode the secure data in the manner stored within the database 11. Instead, such decoding is performed by the connector, which can connect to a particular payment institution, or other intermediary, that will be utilized for that particular transaction. In such an instance, the router 2 can generate messages, such as the messages 36 or 37, which can communicate the secure data in a protected manner, obtained from the database 11, such as via the communication 54, and enable the merchant 4 to receive payment from the first party. Alternatively, or in addition, the first party, such as through the mobile device 1 can generate a “proof of knowledge”, such as data which is not itself secure, but proves that the mobile device 1 is aware of the secure data, such as a credit card number stored on the mobile device 1. Such proof of knowledge can then be transmitted to the router 2, which can verify that the mobile device 1 has, indeed, proved its knowledge of the credit card number by reference to the database 11. Such proof of knowledge could also be transmitted to the bank 5, via the router 2, and the bank can verify that the mobile device 1 has, indeed, proved its knowledge of the credit card number by reference to the database 11. In such an instance, the transfer of value can be effectuated by the bank 5, or other intermediary, based on such proof of knowledge without the secure data ever being transmitted or even stored outside of the bank 5, which can have issued the credit card in the first place.

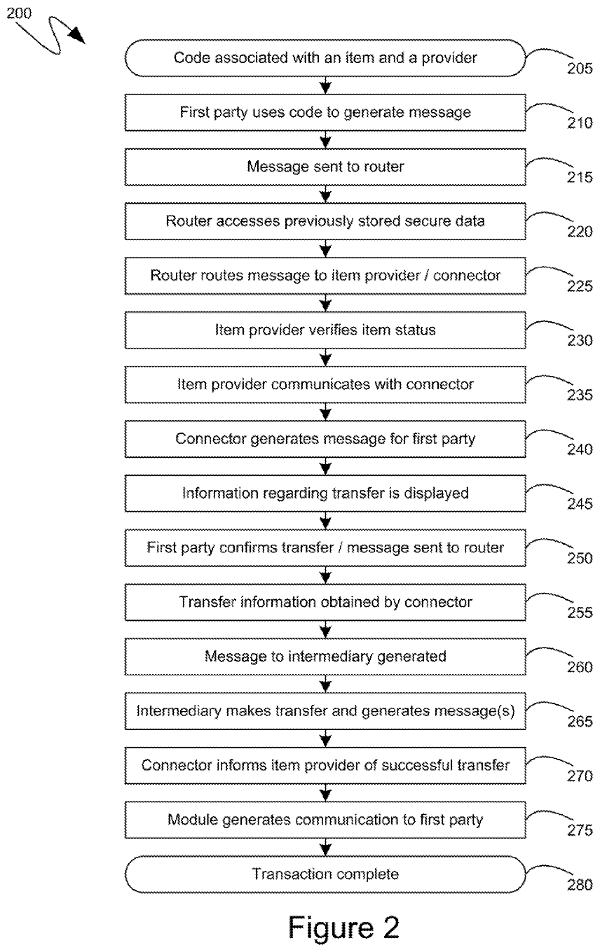

Turning to FIG. 2, the flow diagram 200 shown therein illustrates an exemplary series of operations by which data security can be increased, while simultaneously reducing network congestion by minimizing the quantity and size of messages exchanged on a public network. The list of operations is exemplary, and can be performed in various different orders without departing from the scope of the configurations disclosed herein.

Turning first to step 205, a code associated with an item offered by an item provider, such as a merchant, can be generated. Such a code can be generated by the merchant, utilizing defined mechanisms, or it can be generated by a provider of a system, such as the system 25 shown in FIG. 1. As detailed above, the code can comprise information from which a message, such as an XMPP message, can be constructed for transmission to a router, with the message comprising sufficient information, both to enable the router to route the message to an appropriate endpoint, as well as further information that can be parsed at such an endpoint to identify the item.

At step 210, a customer utilizes the code to generate a message. Such an action can entail scanning a QR code with the camera 14 of the mobile device 1 (shown in FIG. 1), communicating with an NFC device comprising the code data, invoking a deep-link, or any other like consumption and/or utilization of the code generated at step 205.

At step 215, an application 13 executing on a device utilized by the first party, such as the mobile device 1, generates and transmits a message to a server 2 that can include routing information, such as in the form of an LDAP database and/or other types of databases, such as a PostgreSQL database. This message includes information related to the code, including both information to enable the server 2 to route the message to an appropriate endpoint, as well as information that can be consumed by the endpoint to identify a specific item. As indicated previously, such information can be within the code data itself, or, alternatively, or in addition, such information can be within a database to which the code links, or otherwise identifies a specific database entry that can comprise the item identifying information and the item provider identifying information, among other information.

At step 220, the server 2 can reference an internal database, such as the module 10, to determine if the customer has a previously provided secure data to the system 25, and, if such secure data is stored by the module 10, a notification can be generated by the server 2 and transmitted to the mobile device 1 indicating that the purchase has started. As indicated previously, rather than storing secure data as part of the system 25, the system 25 can facilitate communication with a bank, or other like intermediary, with the item provider, such as the merchant 4, providing information such as a quantity of value that is to be transferred, while the first party, such as a customer utilizing a mobile device 1, can provide information such as credit card information, or other secure data. As also indicated previously, the customer can avoid transmission of the secure data itself, and can, instead, transmit a proof of knowledge of the secure data that can be verified, such as by the bank 5.

At step 225, the server 2, based on the data obtained from the mobile device 1, such as data that was part of the message transmitted at step 215, contacts the connector for a specific merchant, such as the message adapter 3. As indicated previously, the message adapter 3 can be executed by the merchant 4, or can be executed by the system 25 on behalf of the merchant to facilitate interaction with the merchant's existing processes and/or databases.

At step 230, the merchant's system can respond to information received from the message adapter 3, including checking the condition, such as the stock status, of the item identified by the message of step 225, and reserving the item if it is available. In parallel to this request, the merchant is provided with information on who reserved the product, depending on what the user entered during registration with the application 13. In at least one configuration, a phone number is the only auditory information. The reservation can be made to be temporary, with a duration that can be configured.

At step 235, the merchant's system 4 returns information containing details of the item to the message adapter 3. This information can contain the product description, price, and other like details

At step 240, the message adapter 3 generates a message with the information received at step 235 for delivery to the mobile device 1 via the server 2. Accordingly, the generated message can comprise an identifier of the mobile device 1, enabling the server 2 to route the message to the mobile device 1.

At step 245, upon receipt of the message of step 240, the application 13 displays information about the merchant, product and price. In this operation, the customer can continue with the payment or cancel the purchase, or shift to scan or click a further item and/or code. In case of canceling, the product reservation at the merchant server is automatically released.

At step 250, the customer clicks on the “Pay” button in the application 13 and the information for purchase (with the required data) is sent back again to the connector 3 through the server 2. Thus, the customer can trigger payment for the product or service simply by scanning the identifying information associated with the product or service. As indicated previously, secure data, such as credit card information or other payment information, can be provided only to the server 2, and not to individual merchants. As also indicated previously, such secure data can be communicated to an intermediary, such as the bank 5, through a proof of knowledge data structure that does not contain the secure data itself.

At step 255, the message adapter 3, or any other adapter that can connect to a merchant, collects the necessary data for payment received from the mobile device 1 and a merchant data for a bank “MDB” module 9, such as a PostgreSQL database, which stores data about the bank through which the payment is further processed for the given merchant. In at least one configuration, this operation can also be performed by the message adapter 44 shown in FIG. 1. Alternatively, or in addition, at step 255 the message adapter 3, or other process executing on behalf of the merchant 4, can provide information to an intermediary, such as the bank 5 to facilitate the transfer of value from the first party to the item provider. While such information can include the secure data identified previously, it can also include information specific to the merchant, such as a bank account of the merchant into which the value is to be transferred. As with credit card data, such bank account information can be secure data that can be stored only by the merchant 4 and the bank 5, and, consequently, proof of knowledge can be utilized to communicate such secure data.

At step 260, the connector 3 sends the necessary data to the bank 5, such as by generating one or more messages to the server 2, which cause the server to generate messages to one or more adapters and/or connectors for a bank, such as the messages 36 or 37, to the adapters 6 and 7, respectively. The connectors 6 and 7 can interface directly with the bank's system 5 with all the necessary data to make the payment or otherwise enable the bank to facilitate the transfer of value from the first party to the item provider.

At step 265, the bank 5, such as through an API, returns data on whether the payment, reservation or other transfer of funds and/or other value, has been successful. Such data can be received by the adapter 7, which forwards this information to the merchant's adapter 3 and the mobile device 1.

At step 270, the merchant's adapter 3 informs the merchant's system 4 whether the payment/reservation of funds has been successfully completed or not, and that the product has been purchased in case of the former.

At step 275, the adapter 3 also sends information about the result of the transaction to an email module 8 or other like external communication channel, which can then send this information to the mobile device 1, such as via email, text, or any other way of sending information to the mobile device 1. Thus, basic purchase flow is now completed. Operations of the purchase process described herein can vary depending on whether the customer registers credit card information with the server 2 or enters the credit card information each time when paying, whether it is a first payment with a specific card, whether there are available funds on the card, and the like. The transaction can then complete at step 280.

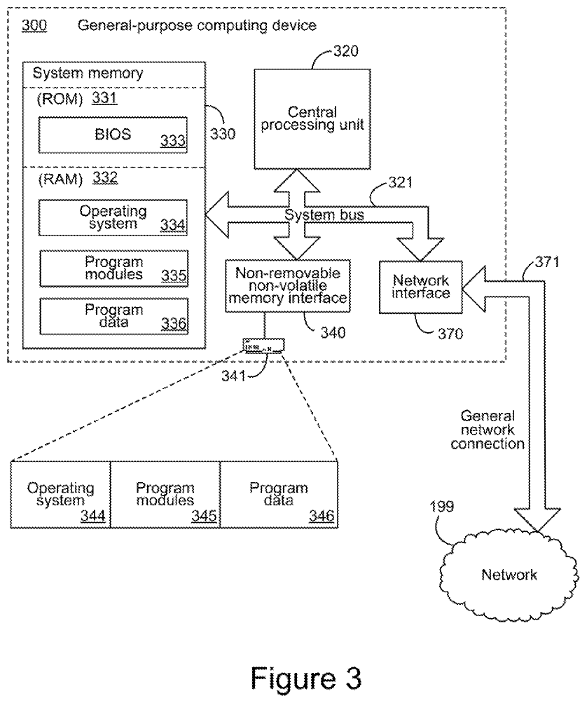

With reference to FIG. 3, an exemplary general-purpose computing device is illustrated in the form of an exemplary general-purpose computing device 300. The general-purpose computing device 300 may be of the type utilized for the mobile device 1, the router 2, and/or any of the devices executing one or more of the components of the shopping system 25 described above with relation to FIG. 1, as well as the other computing devices with which the shopping system 25 may communicate through outside communication network 199. All of the components of the shopping system 25 shown in FIG. 1 can communicate as described above via the outside communication network 199. As such, it will be described with the understanding that variations can be made thereto. The exemplary general-purpose computing device 300 can include, but is not limited to, one or more central processing units (CPUs) 320, a system memory 330 and a system bus 321 that couples various system components including the system memory to the processing unit 320. The system bus 321 may be any of several types of bus structures including a memory bus or memory controller, a peripheral bus, and a local bus using any of a variety of bus architectures. Depending on the specific physical implementation, one or more of the CPUs 320, the system memory 330 and other components of the general-purpose computing device 300 can be physically co-located, such as on a single chip. In such a case, some or all of the system bus 321 can be nothing more than communicational pathways within a single chip structure and its illustration in FIG. 3 can be nothing more than notational convenience for the purpose of illustration.

The general-purpose computing device 300 also typically includes computer readable media, which can include any available media that can be accessed by computing device 300. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 300. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computing device 300, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, other program modules 335, and program data 336.

When using communication media, the general-purpose computing device 300 may operate in a networked environment via logical connections to one or more remote computers. The logical connection depicted in FIG. 3 is a general network connection 371 to the network 199, which can be a local area network (LAN), a wide area network (WAN) such as the Internet, or other networks. The computing device 300 is connected to the general network connection 371 through a network interface or adapter 370 that is, in turn, connected to the system bus 321. In a networked environment, program modules depicted relative to the general-purpose computing device 300, or portions or peripherals thereof, may be stored in the memory of one or more other computing devices that are communicatively coupled to the general-purpose computing device 300 through the general network connection 371. It will be appreciated that the network connections shown are exemplary and other means of establishing a communications link between computing devices may be used.

The general-purpose computing device 300 may also include other removable/non-removable, volatile/nonvolatile computer storage media. By way of example only, FIG. 3 illustrates a hard disk drive 341 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340.

The drives and their associated computer storage media discussed above and illustrated in FIG. 3, provide storage of computer readable instructions, data structures, program modules and other data for the general-purpose computing device 300. In FIG. 3, for example, hard disk drive 341 is illustrated as storing operating system 344, other program modules 345, and program data 346. Note that these components can either be the same as or different from operating system 334, other program modules 335 and program data 336. Operating system 344, other program modules 345 and program data 346 are given different numbers here to illustrate that, at a minimum, they are different copies.

Although described as a single physical device, the exemplary computing device 300 can be a virtual computing device, in which case the functionality of the above-described physical components, such as the CPU 320, the system memory 330, the network interface 370, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need an availability. In the situation where the exemplary computing device 300 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

With reference to FIG. 1, again, the foregoing description applies to the shopping system 25, as well as to any other computing devices in communication with the shopping system 25 through outside communication network 199. The CPU 320 is coupled to the network interface 370. The network interface 370 facilitates outside communication in the form of voice and/or data. For example, the communication module may include a connection to a Plain Old Telephone Service (POTS) line, or a Voice-over-Internet Protocol (VOIP) line for voice communication. In addition, the network interface 370 may be configured to couple into an existing network, through wireless protocols (Bluetooth, 802.11a, ac, b, g, n, or the like) or through wired (Ethernet, or the like) connections, or through other more generic network connections. In still other configurations, a cellular link can be provided for both voice and data (i.e., GSM, CDMA or other, utilizing 2G, 3G, and/or 4G data structures and the like). The network interface 370 is not limited to any particular protocol or type of communication. It is, however, preferred that the network interface 370 be configured to transmit data bi-directionally, through at least one mode of communication. The more robust the structure of communication, the more manners in which to avoid a failure or a sabotage with respect to communication, such as to communicate an audio segment(s) in a timely manner.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

1. A method for increasing data security and reducing network congestion, the method comprising:
generating, based on a received code, a first message to a router, the first message comprising an item identifier and an item provider identifier, the code providing the item identifier and the item provider identifier;
routing, by the router, the first message to an item provider associated with the item provider identifier, the routing being based on the first message comprising the item provider identifier;
generating a second message to the router, the second message comprising an intermediary identifier associated with an intermediary and information for the intermediary to perform a transfer from a first party to the item provider;
routing, by the router, the second message to the intermediary, the routing being based on the second message comprising the intermediary identifier;
generating a third message to the router, the third message comprising transfer authorization information and the intermediary identifier;
routing, by the router, the third message to the intermediary, the routing being based on the third message comprising the intermediary identifier;
verifying, in response to receiving the third message, a secure data based on the transfer authorization information, the secure data enabling the transfer.

2. The method of claim 1, wherein the code is a QR code, and wherein further the generating the first message comprises scanning the QR code.

3. The method of claim 2, wherein the generating the first message comprises obtaining, prior to generating the first message, at least one of the item identifier or the item provider identifier from the router based on initial information obtained from the received code, the code indirectly providing the item identifier and the item provider identifier by providing the initial information, the initial information utilizable by the router to directly provide the at least one of the item identifier or the item provider identifier.

4. The method of claim 1, wherein the code is received through Near Field Communications (NFC) from an NFC device, the code directly providing the item identifier and the item provider identifier.

5. The method of claim 4, wherein the code further comprises detailed item information.

6. The method of claim 1, wherein the routing the first message to the item provider comprises routing the first message to an item provider connector, the item provider connector parsing the first message and interfacing with the item provider in accordance with existing item provider processes and data storage.

7. The method of claim 1, wherein the routing the second message to the intermediary comprises routing the second message to an intermediary connector, the intermediary connector parsing the second message and interfacing with the intermediary in accordance with an existing intermediary application program interface (API).

8. The method of claim 1, wherein the generating the first message comprises generating an XMPP message.

9. A system comprising:
a mobile device application performing steps comprising:
scanning a code, the scanning providing an item identifier and an item provider identifier; and
generating, based on the code, a first message to a router, the first message comprising the item identifier and the item provider identifier;
an item provider connector performing steps comprising:
receiving the first message;
parsing the first message; and
interfacing with the item provider in accordance with existing item provider processes and data storage; and
a router performing steps comprising:
routing the first message to the item provider connector based on the first message comprising the item provider identifier.

10. The system of claim 9, wherein the code is a QR code, and wherein further the generating the first message comprises scanning the QR code.

11. The system of claim 10, wherein the generating the first message comprises obtaining, prior to generating the first message, at least one of the item identifier or the item provider identifier from the router based on initial information obtained from the received code, the scanning of the code indirectly providing the item identifier and the item provider identifier by providing the initial information, the initial information utilizable by the router to directly provide the at least one of the item identifier or the item provider identifier.

12. The system of claim 9, wherein the scanning the code comprises establishing Near Field Communications (NFC) with an NFC device, the established NFC transferring the code to the mobile device from the NFC device, the code directly providing the item identifier and the item provider identifier.

13. The system of claim 12, wherein the established NFC further transfers detailed item information to the mobile device from the NFC device.

14. The system of claim 9, wherein the generating the first message comprises generating an XMPP message.

15. The system of claim 9, wherein the item provider connector performs further steps comprising:
generating a second message to the router, the second message comprising an intermediary identifier associated with an intermediary and information for the intermediary to perform a transfer from a first party to the item provider.

16. The system of claim 15, further comprising:
an intermediary connector performing steps comprising:
receiving the second message;
parsing the second message; and
interfacing with the intermediary in accordance with an existing intermediary application program interface (API).

17. The system of claim 15, wherein the information for the intermediary to perform a transfer from a first party to the item provider comprises proof of knowledge of a secure data.
